(19) United States
(12) Patent Application Publication
(10) Pub. No.: US 2016/0160549 A1
(43) Pub. Date: Jun. 9, 2016

(54) FACEPLATE BODY FOR A FUNCTIONALLY ESSENTIAL STRUCTURAL COMPONENT WITH A SUPPORT ELEMENT MADE FROM PLASTIC MATERIAL

(71) Applicant: DORMA Deutschland GmbH, Ennepetal (DE)

(72) Inventor: Bernhard HEITZ, Ennepetal (DE)

(21) Appl. No.: 14/958,738

(22) Filed: Dec. 3, 2015

(30) Foreign Application Priority Data
Dec. 4, 2014 (EP) 14196288.6

(51) Int. Cl. E05D 11/00; E06B 3/30

(52) U.S. Cl. CPC E05D 11/0054; E06B 3/308

(57) ABSTRACT

A faceplate body for a functionally essential structural component, in particular for a fitting with a faceplate having at least the appearance of a decorative element, and with a support element, includes at least one attachment means. The attachment means is configured for attaching to the functionally essential structural component. The support element is configured from a plastic material.

### TECHNICAL FIELD

The disclosure relates to a faceplate body for a functionally essential structural component, in particular for a fitting

### BACKGROUND

Conventional faceplates are particularly disposed at door fitting and/or corner fittings of doors or walls, in particular made from glass. Said faceplates are made from metal, sheet metal as well as often three-dimensionally formed, wherein the shaping is to be adapted individually with regard to the structural component. Moreover, it has substantially proven to be disadvantageous that the manufacturing methods of such faceplates are difficult, expensive and not at all flexible with regard to the overall manufacturing process. In addition to the relatively high weight of the faceplate, it is disadvantageous that complicated attaching connections are often necessary to dispose the faceplate reliably at the functionally essential structural component, in particular at the fitting.

The present disclosure overcomes the above-described disadvantages. The present disclosure provides an inexpensive and simple faceplate for a functionally essential structural component, wherein in addition a simple mounting can be achieved.

### SUMMARY

According to the disclosure, a faceplate body is intended for a functionally essential structural component, in particular for a fitting a faceplate having with at least the appearance of a decorative element, and with a support element, which includes at least one attaching means for achieving an attachment to the functionally essential structural component, wherein the support element is made from a plastic material. According to the disclosure, a support element is proposed, which can be simply adapted to different geometrics of the functionally essential structural component, wherein the support element is embodied in a plastic material, whereby the overall weight can be considerably reduced. The support element may be for example a plastic injection molding part or a 3-D-print part. The support element may include one or more attaching means, which are suitable for a reliable fixing of the faceplate body at the functionally essential structural component. The faceplate is in particular applicable for a fitting for glass doors or glass walls.

The configuration of the carrying material from plastic material includes a just partial configuration of plastic material. Thus a surface layer, e.g. varnish or a laminate may be disposed e.g. on the plastic material. In addition or as an alternative, the carrying material may include reinforcing material e.g. carbon fibers. In a particularly preferred embodiment, the carrying material is completely configured from plastic material.

Advantageously, a faceplate, which is configured for different functionally essential structural components, may be utilized, wherein depending on the geometrics of the functionally essential structural component, a support element correspondingly embodied in plastic material is employed, which is connected to the faceplate. Advantageously, the faceplate body is composed of at least the decorative faceplate and the support element. The faceplate as well as the support element may be embodied for example in a common body, which means that the faceplate and the support element form a monolithic, common structural component. Therefore, said structural component, which is embodied in plastic material, is able to considerably contribute to the weight reduction. Corresponding attaching means ensure that the faceplate body can be quickly attached to the functionally essential structural component without essential mounting expense.

It is likewise conceivable that different attaching means are disposed in particular at the faceplate and/or at the support element, which, depending on the different functionally essential structural components, justify their attaching function. This means a faceplate body can be standardized for being disposed at different geometrics of functionally essential structural components. Advantageously, the attaching means may be disposed at different positions at the faceplate body, wherein, depending on the geometrics of the functionally essential structural component, their function as an attaching means is required or not.

It may be advantageous that the faceplate as well as the support element are embodied from different structural components, wherein the support element is attached to the faceplate via connecting elements. In this embodiment as well a faceplate, which is configured identical for different functionally essential structural components, may be employed and attached to the support element, wherein for example the support element includes at least one attaching means for fixing the faceplate body at the functionally essential structural component.

It is furthermore advantageous, if the attaching means with the support element forms a common, monolithic structural component and/or the attaching means is integrally interconnected to the support element. Thus, the number of structural components at the faceplate body can be reduced, wherein advantageously it has proven that hereby a simple mounting of the faceplate body to the functionally essential structural component can be achieved. Moreover, if the attaching means is incorporated at the support element, the manufacturing cost can be reduced.

It is likewise advantageous, if the attaching means includes a latching element and/or a clips element. On the one hand, such attaching means are easily manufactured, in particular as a plastic injection molding part. Another advantage is that such attaching means facilitate a particularly simple mounting.

Moreover, it is conceivable that the faceplate may be made from a material, which is metal or glass or lumber or leather or plastic material. Thus, a faceplate body according to the disclosure can be provided, which satisfies the most various design wishes. A metal faceplate is distinguished by its high stability, wherein in addition the metal represents an increased protection function for the functionally essential structural component. In the event the faceplate body is employed at glass walls/glass doors, a faceplate made from glass could be indicated, whereby an overall uniform appearance can be achieved. The faceplate made from plastic material may include different design embodiments, in particular realized in one or diverse colors. In one possible embodiment of a faceplate made from plastic material, it may be provided according to the disclosure that the surface of the faceplate is coated, wherein the color and/or the material of the coating can be adapted according to the field of application and/or to customer specifications.

Moreover, the disclosure may comprise that the faceplate includes a flat plate element, which has a front side and a back side, wherein the back side is facing the support element, in particular the back side is attached to the support element. The connecting elements, which are provided at the faceplate and/or at the plate element and/or at the support element, are able for example to achieve an effective attachment of the faceplate/plate element to the support element.

It is likewise advantageous, if the support element is configured with a cavity, which is able to accommodate at least partially the functionally essential structural component, wherein in particular the cavity is delimited by a walling, in particular a surrounding walling. Furthermore, a bottom of the support element may delimit the cavity. One advantage of the cavity consists in being able to create a compact overall arrangement of the faceplate body with the functionally essential structural component. Advantageously, in its assembled condition the functionally essential structural component is at least partially located in the cavity, in particular it is accommodated in the cavity. The walling conceals in particular at least partially the functionally essential structural component and thereby serves as a visual protection with regard to the functionally essential structural component. Thus, it is conceivable that the support element serves as a type of housing for the functionally essential structural component and may include in addition a certain protecting function.

In a measure enhancing the disclosure, it may be provided that the support element is disposed in such a way at the faceplate that the support element is visible from the outside. In this case, it is conceivable that the support element is visible at least on one side of the faceplate body, preferably at least on two sides of the faceplate body, in particular preferred at least on three sides of the faceplate body. The support element may as well be visible on four sides of the faceplate body. Preferably, the support element is invisible at a front side of the faceplate body. A front side of the faceplate may in particular form the forefront of the faceplate body. In particular preferred, the sides of the faceplate may be visible at the sides of the faceplate body.

The faceplate may be in particular disposed at the support element that the bottom is concealed by the faceplate and/or the walling is at least partially visible from outside in the mounted condition of the functionally essential structural component. One advantage in this case is that material can be saved with regard to the faceplate, because the support element is positioned between the faceplate and the functionally essential structural component and thus the faceplate does not have to extend as far as to the functionally essential structural component. As an additional effect, a floating impression of the faceplate is created for the user. The floating impression is enhanced in that the faceplate and the support element differ in color and/or material.

It is likewise advantageous that the bottom serves as a locating element for the faceplate. The walling may screen and cover the functionally essential structural component at least partially from outside.

Furthermore, the disclosure may comprise that the faceplate and the support element are embodied in that the faceplate body includes at least one rounded corner area and/or at least one angular corner area. The rounded corner area has the advantage of excluding potential risk of injury. The angular corner area, which is preferably disposed on the inside of the faceplate and thus likewise does not pose any risk of injury, has the advantage of the least possible loss of material during manufacturing. In contrast to the angular corner area, the one or more rounded corner areas are located on the outside at the faceplate. In particular a corner area, which is configured to be disposed facing an edge of the wall or of the door, is understood as “inside located”. Hereby, in particular another faceplate body may adjoin the corner area. In particular a corner area, which is configured to be disposed facing away from an edge of the wall or of the door, is understood as “outside located”. Hereby, in particular no other faceplate body adjoins the corner area.

Moreover it is advantageous that the attaching means is configured in such a way at the support element that the attaching means is invisible from outside, in particular that the attaching means is located in the cavity. Another advantage is found in that hereby a manipulation protection is effectively installed at the faceplate body. In addition it has proven that the invisible attaching means creates an elegant design for the faceplate body.

Furthermore, an inventive faceplate body provides that the walling includes the at least one attaching means. It has proven useful to provide the at least one attaching means at the walling in particular at the surrounding walling, because hereby advantageous attaching options to the functionally essential structural component are created.

In addition, the disclosure comprises that the support element includes several attaching means, wherein the attaching means are configured such that at least two attaching means in the mounted condition at the functionally essential structural component differ in their holding force at the functionally essential structural component. A simple attachment of the faceplate body to the functionally essential structural component is hereby created. In addition, the above-mentioned features allow for achieving secure retaining of the faceplate body at the functionally essential structural component. It may be provided for example that one attaching means having a larger holding force is employed, wherein the installation technician will use this attaching means initially for inserting the faceplate body at the functionally essential structural component. Once the desired position of the faceplate body at the functionally essential structural component is created with regard to the mentioned attaching means, the remaining part of the faceplate body can be moved to the functionally essential structural component and/or pivoted, wherein the attaching means having the larger holding force always remains in contact with the functionally essential structural component. A second attaching means having a lower holding force is elastically deformed when transferring the faceplate body into its final mounting position. Once the final mounting position of the faceplate body is reached, the attaching means with the lower holding force springs back in the direction of the basic position, in which both attaching means, the one with the larger and the one with the lower holding force ensure reliable retention of the faceplate body at the functionally essential structural component.

In addition, it may be advantage that the at least one attaching means extends into the cavity. Thus, a compact construction type of the faceplate body is achieved, wherein also a design advantage can be achieved, because the attaching means are invisible from outside.

It is likewise advantageous that the support element is configured frame-like. Such a geometric configuration of the support element favors that a reliable attaching effect is achieved at diverse sides of the functionally essential structural component. Advantageously, the geometrics of the support element are adapted to the geometrics of the functionally essential structural component.

The disclosure may likewise comprise that the course of the support element is adapted to the exterior contour of the faceplate, in particular that the faceplate has a geometric shape, which is rectangular or square or angular or L-shaped. In addition, it is conceivable that the course of the support element is interrupted at least on one side. It is advantageous that functional elements, which may at least partially protrude from the faceplate body, may be provided within the functionally essential structural component. For allowing said feature, it may be advantageous that the support element is embodied open at least to one side, in particular interrupted on one side.

Another advantage of the disclosure may provide that the walling includes at least four walling sides, wherein in particular at least two opposite walling sides include the attaching means, in particular only two walling sides include attaching means. Surprisingly, it was revealed that a reliable attachment effect could be already achieved, if attaching means are provided at only two walling sides.

Advantageously, the attaching means may be disposed along the longitudinal extension of the faceplate body. In addition, it is likewise conceivable that an opening at the support element is associated to each attaching means, wherein in particular the bottom includes the opening. The openings are created in a simple injection molding process, whereby the manufacturing process for the support element is simplified. Thus, no pushers are required in the tool during the injection molding process.

The disclosure may likewise comprise that the faceplate is positively and/or non-positively and/or connected by substance to the support element, in particular at least one connecting element, which is invisible from the outside, ensures that a reliable attachment between the faceplate and the support element is given. In addition to a latching connection and/or clips connection between the support element and the faceplate, as an alternative or in addition, an adhesive medium is conceivable as connecting element. It has proven to be advantageous to achieve a good attaching effect, if the faceplate is embodied from glass and an adhesive medium is used as the connecting element between the faceplate and the support element. In the event the faceplate is made from metal, it may be advantageous to employ a non-positive and/or positive connection between the faceplate and the support element.

### BRIEF DESCRIPTION OF THE DRAWINGS

Further advantages, features and details of the disclosure will result from the following description, in which several embodiments of the disclosure are described in detail, reference being made to the drawings. In this context, the features mentioned in the claims and in the description, individually or randomly combined, may be essential to the disclosure. In the drawings:

FIG. 1 shows a diagrammatically illustrated faceplate arrangement with several faceplate bodies disposed next to each other,

FIG. 2 shows a faceplate arrangement with a functionally essential structural component and faceplate bodies disposed thereat,

FIG. 3 shows a diagrammatical view of a faceplate body, in which a functionally essential structural component is disposed,

FIG. 4 shows a faceplate body with a faceplate and a support element,

FIG. 5 shows a faceplate body according to FIG. 4 in a further view,

FIG. 6 shows another exemplary embodiment of a support element, which can be inserted into a faceplate body of FIGS. 1 to 5,

FIG. 7 shows the support element according to FIG. 6 in a further illustration,

FIG. 8 shows another exemplary embodiment with a functionally essential structural component, to which a support element is attachable,

FIG. 9 shows a further exemplary embodiment of a faceplate arrangement with two faceplate bodies and a functionally essential structural component, which is surrounded by the faceplate body,

FIG. 10 shows a further exemplary embodiment of a support element with a protecting element,

FIG. 11 shows a further exemplary embodiment of a support element,

FIGS. 12a, 12b, and 12c show method steps for the attachment by substance of a connecting element to a faceplate, in particular to a plate element,

FIG. 13 shows a further illustration of a faceplate arrangement with two faceplate bodies, which surround a functionally essential structural component, and

FIGS. 14a, 14b, and 14c show a diagrammatical method illustration for manufacturing a faceplate body.

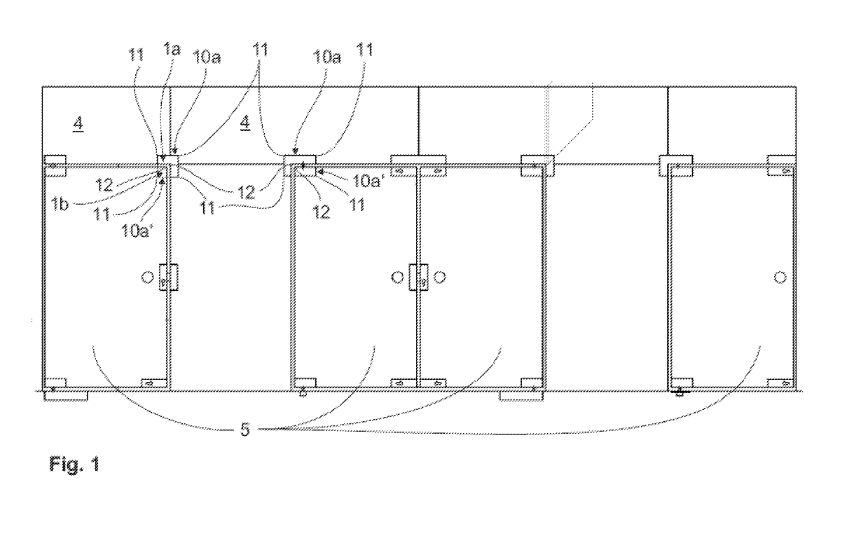

Elements and feature having the same function and mode of action are indicated in the FIGS. 1 to 13 respectively with the same reference numeral.

### DETAILED DESCRIPTION OF DRAWINGS

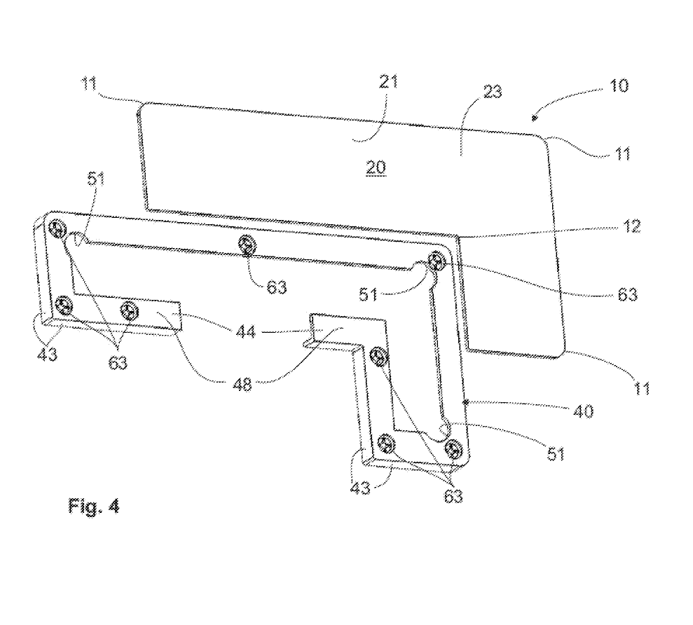

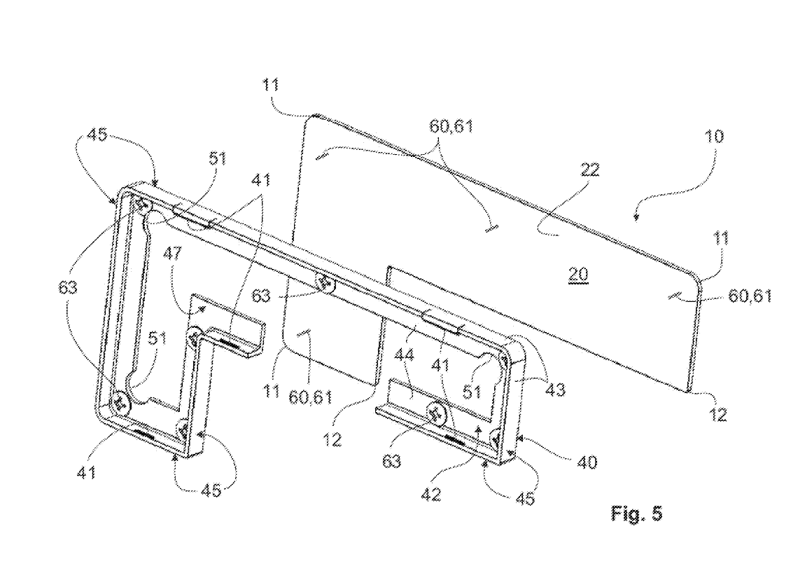

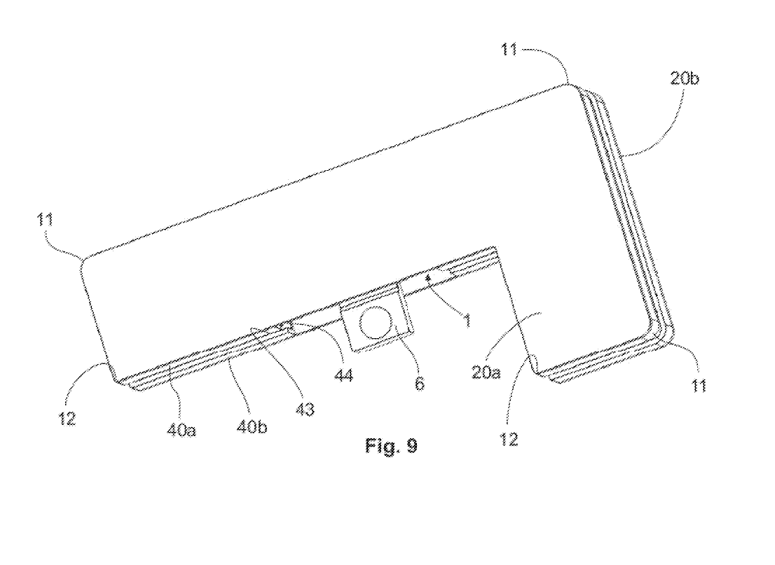

FIG. 1 shows a possible faceplate arrangement with various faceplate bodies 10a, 10a′, which cover a functionally essential structural component 1a, 1b. The faceplate bodies 10a, 10′ are disposed next to each other, wherein the faceplate bodies 10a, 10a′ are respectively adapted to the neighboring contour. In this case, a first faceplate body 10a is disposed at a first functionally essential structural component, which is explicitly not illustrated. Said first structural component is at least partially covered by the first faceplate body, which will be explained in the following. Likewise, the second faceplate body 10a′ is disposed at another second functionally essential structural component 1b, which likewise explicitly cannot be seen in FIG. 1. The second structural component 1b is partially covered by the second faceplate body 10a′. The first 10a and the second faceplate bodies 10a′ include several corner areas 11, 12, wherein the corner areas 12 of the first faceplate body 10a, which are facing the second structural component 1b, are configured as angular corner areas 12. The corner areas 11 of the first faceplate body 10a, which are facing away from the second structural component 1b, are configured as rounded corner areas 11, as also illustrated in FIG. 4, FIG. 5, and FIG. 9. The first faceplate body 10a′ is disposed at a mobile door element 5. The second faceplate body 10a′ is attached to stationary wall elements 4. The functionally essential structural components 1a, 1b, which are respectively covered by the faceplate bodies 10a, 10a′, may have different technical functions. It is for example conceivable that an axis of rotation is disposed in one of the functionally essential structural components 1a, 1b, or a bolt, which serves for interlocking, etc. According to FIG. 1, the faceplate body 10a′ is configured to be angular, in particular L-shaped.

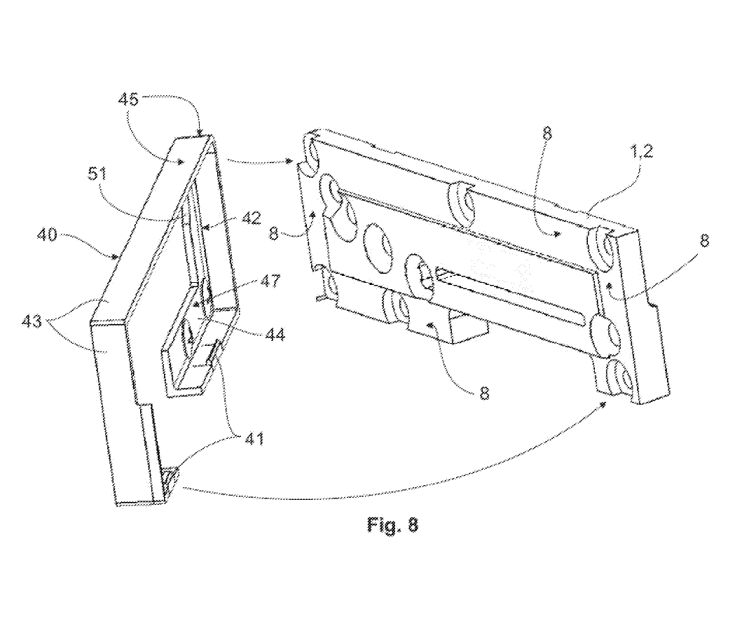

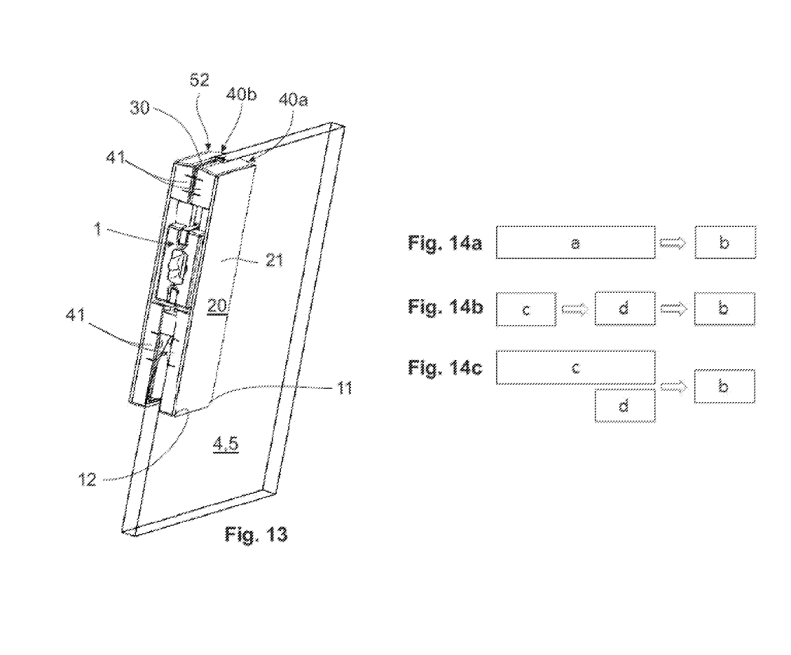

According to all exemplary embodiments, the faceplate body 10 is designed for a functionally essential structural component 1, in particular for a fitting 1 or a corner fitting, wherein the faceplate body 10 includes at least one faceplate 20 as well as a support element 40, which refers to all exemplary embodiments. According to FIG. 4, the faceplate 20 has a plate element 23 with a front side 21 and a back side 22. The plate element 23 is attachable to a support element 40. The rear view according to FIG. 5 illustrates that the support element 40 includes a cavity 42, in which attaching means 41 are disposed, which serve for attaching the support element 40 to a functionally essential structural component 1, which is shown for example in FIG. 3, FIG. 8 or FIG. 13.

The support element 40 includes a walling 43, which is configured to be surrounding and frame-like. Moreover, the support element 40 is configured with a bottom 44, which serves as a locating surface for the faceplate 20, in particular for the plate element 23 and for the functionally essential structural component 1.

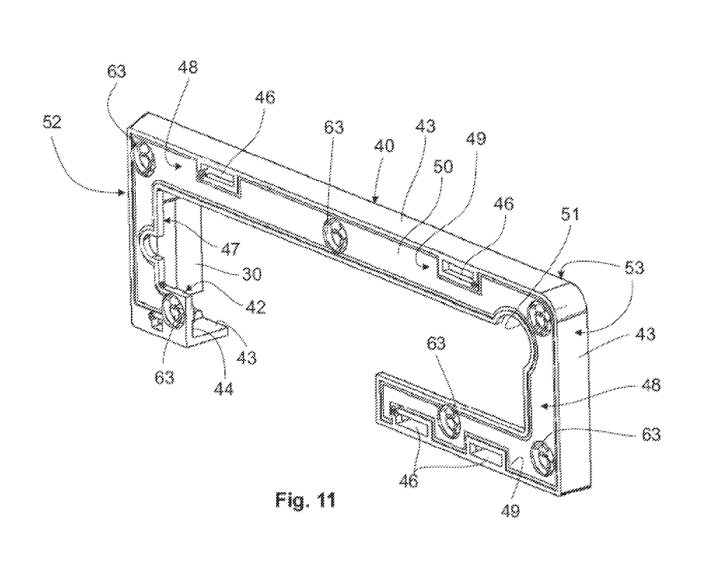

The support element has several walling sides 45, wherein in the exemplary embodiments, the attaching means 41 only include two opposing walling sides 45. The bottom 44 includes an interior side 47, which is facing the functionally essential structural component 1. Furthermore, the bottom 44 includes an exterior side 48, which is associated to, respectively facing the faceplate 20, in particular the plate element 23. The plate element 23, in particular the faceplate 20 will be and/or is positively and/or non-positively connected to the support element 40, this is valid for all exemplary embodiments, wherein one exception is shown in FIG. 11, in which the exterior side 48 of the support element 40 has a depression 49, into which a connecting element 60, in particular an adhesive medium 50 can be introduced, such that when contacting the faceplate 20, in particular of the plate element 23 with the exterior side 48 of the support element 40, a reliable connection by substance can be realized. It is likewise conceivable that according to FIG. 11 in addition a non-positive and/or positive connection is realized between the support element 40 and the faceplate 20, in particular the plate element 23.

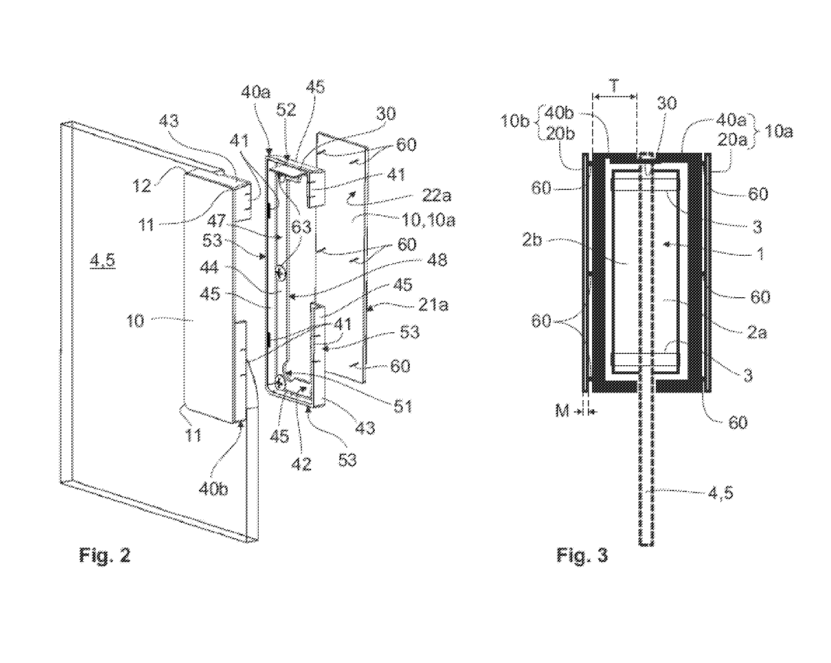

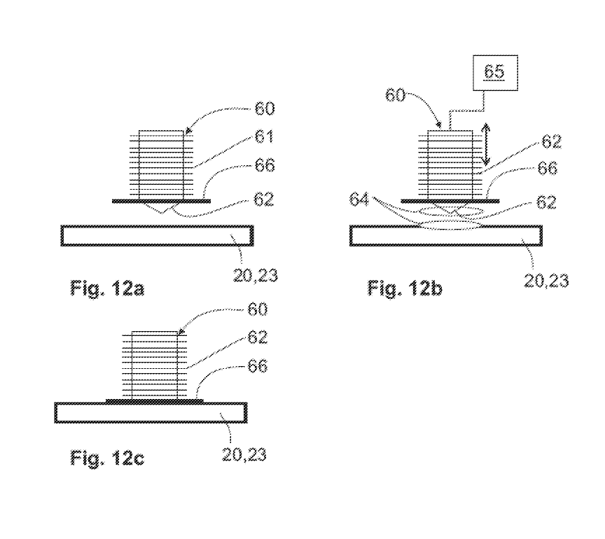

In FIG. 2, FIG. 3, FIG. 5, the connecting elements 60 are shown, which are disposed at the faceplate 20, in particular at the plate element 23, for realizing a non-positive and/or positive connection with the support element 40. The connecting elements 60 may be affixed for example by means of a welding method to the faceplate 20, in particular to the plate element 23, which is shown in FIGS. 12a, 12b, and 12c and FIGS. 14a, 14b, and 14c diagrammatically and will be explained in the following.

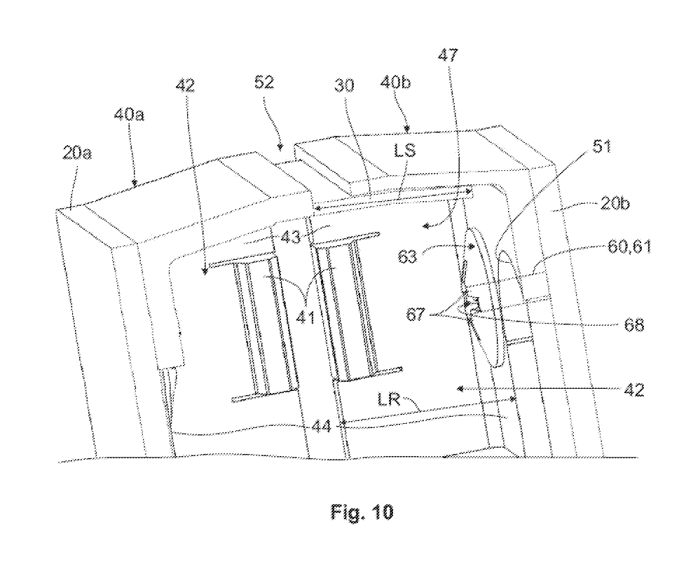

The faceplate body 10 has counter-latching elements 63 at the support element 40, which are configured as elastic wing elements. By way of example FIG. 10 shows for all exemplary embodiments that the counter-latching element 63 moreover comprises an opening 68, into which the latching element 61 engages Advantageously, the latching element 61 includes a thread, which is embodied from a plurality of depressions, whereby at least one form closure with the wing elements 67 of the counter-latching element 63 is realized. Thus, a reliable attaching effect is achieved between the plate element 23, respectively the faceplate 20 and the support element 40.

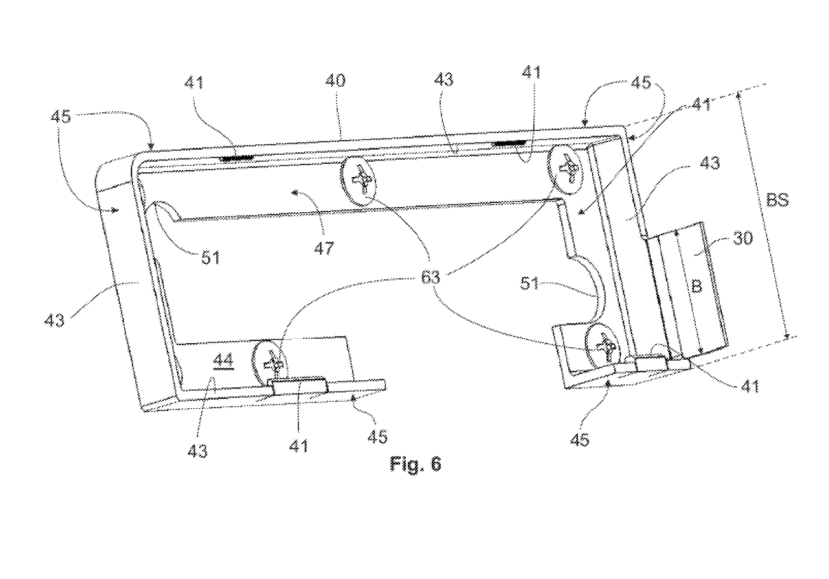

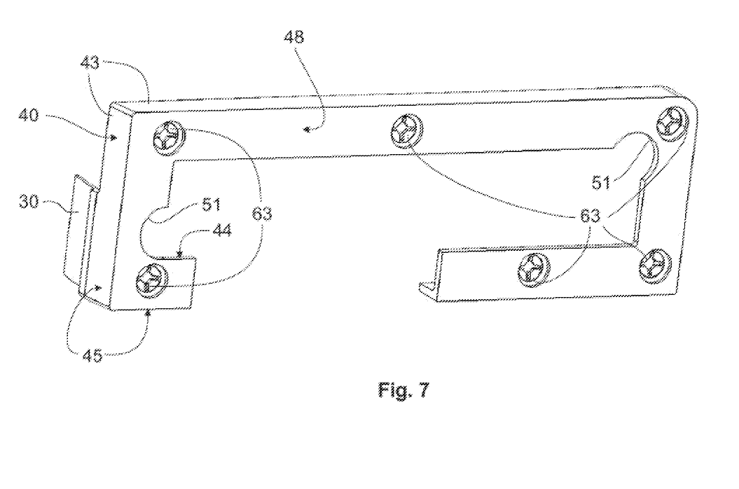

As revealed in all illustrations of the Figures, the support element 40 has one or more apertures 51, which serve for creating a free space for functional elements of the functionally essential structural component 1. The exemplary embodiment according to FIG. 2, FIG. 7, FIG. 8, and FIG. 6 corresponds essentially to a faceplate body 10 according to the above-described Figures, wherein the faceplate body 10 presents a rectangular-shaped embodiment instead of an L-shape. In all embodiments, the support element 40 is configured frame-like, in which at least one location, respectively one area is interrupted. One reason for this is that the functional elements of the functionally essential structural component 1 are hereby allowed to reach through this area and by way of example this is illustrated in FIG. 13 or FIG. 9. In FIG. 13, one element 1 of the functionally essential structural component 1 is shown, which extends through the break-through of the support element 40. FIG. 9 shows an abutting element 6, which extends like a protrusion from the faceplate arrangement. Said abutment 6 may be a door stop, in particular for the door 5 according to FIG. 1.

FIG. 8 shows a device with a faceplate body, in which just the support element 40 is shown, wherein the support element 40 can be affixed to a functionally essential structural component 1. The functionally essential structural component 1 includes a depression 8, into which the support element 44 extends with the bottom 44 thereof. This means, the geometric dimensions of the depression 8 are correspondingly adapted to the geometric dimension of the bottom such as to create a compact overall unit in the assembled condition.

In FIG. 2, FIG. 3, FIG. 6, FIG. 7, FIG. 10, FIG. 11, and FIG. 13 the faceplate body 10 is configured with a protecting element 30, which laterally covers and protects the functionally essential structural component 1. The first faceplate body 10a includes a first faceplate 20a, at which a first frame element 40a is disposed. Moreover, a second faceplate body 10b comprises a second faceplate 20b, at which a second frame element 40b is disposed. The first frame element 40a includes the protecting element 30, which as a protrusion extends in the direction of the second faceplate body 10b, in particular of the second frame element 40b. In this case, the protecting element 30 is located below the second frame element 40b. Thus, an asymmetrical structural unit is created with regard to both faceplate bodies 10a, 10b. The support elements 40a, 40b are disposed spaced apart from each other at the functionally essential structural component 1. Moreover, the protecting element 30 connects the first support element 40a to the second support element 40b. In particular in FIG. 2, it is revealed that, at least on one side of the support element 40, the surrounding walling 43 presents a slanted course to the bottom 44. The slanted course can be seen there at the support element 40, where the reference numeral 43 of the support element 40b points to. The support element 40a, 40b has several sides, which are formed by the walling 43, wherein one side 52 is configured as a protecting side 52, which includes the protecting element 30. Said side 52 is likewise configured slanted towards the bottom 44.

FIGS. 12a-12c and FIGS. 14a-14c show by way of example the manufacturing of a faceplate 20, in particular for disposing connecting elements 60 at the plate element 23 at the faceplate 20. Initially, the plate element 23 is manufactured, wherein the plate element 23 is configured bending-free from metal according to the illustrated exemplary embodiment. In a step A, the connecting element 60 is disposed at the faceplate 20 in a welding process. According to step a), the connecting element and the plate element 23 are melted in a step c), wherein a melt 64 forms. Subsequently, the connecting element 60 is lead into the melt 64 of the plate element 23, which is realized in a step d). In step c) shown in FIG. 12b, there is a distance between the connecting element 60 and the plate element 23. According to the disclosure, a lifting device 65 is provided for realizing that the connecting element 60 is moved closer to the plate element 23. The connecting element 60 includes a free tapering end 62 as well as a thread 61, which is made from a plurality of depressions, whereby the thread 61 is thus formed from a plurality of latching elements 61, which cooperate with counter-latching elements 63 when attaching to the frame element 40 and thus form a reliable latching connection. Above the free end 62, the connecting element 60 includes a collar element 66, which acts as a positioning help during step d) (FIG. 12). According to FIG. 14, in step a) the connecting element 60 is disposed at the flat plate element 23 in a welding process. Subsequently, according to step b), an attachment of the support element 40 to the faceplate 20 is realized. FIG. 14b shows that during the step a) step c) is realized, in which both the connecting element 60 and the plate element 23 are melted, and a melt 64 is respectively created at the plate element 23 and the connecting element 60. Subsequently, the connecting element 60 is lead into the melt 64 of the plate element 23 in a step d). According to FIG. 12c, it is shown that step d) can be already performed during step c).

FIG. 11 shows that the support element 40 may include openings 46, which are associated to each attaching means 41. Said openings 46 result from an inexpensive injection molding process for efficiently producing the attaching means 41. FIG. 1 to FIG. 3, as well as FIG. 13 show that the device having two faceplate bodies 10, a wall element 4 or a door element 4 can be effectively accommodated. It has proven to be particularly advantageous that the ratio V of material thickness M of the faceplate 20 and depth T of the support element 40 amounts approximately to 5%≦V≦35%, see FIG. 3. In the event the faceplate 20 is made from metal, according to the disclosure the following ratio V is suggested: 10%≦V≦25%, which is particularly advantageous. In the event the faceplate 20 is made from glass, the ratio V 15%≦V≦35 has proven to be particularly advantageous.

The length of the protecting element 30 is dimensioned such that different geometrics can be covered by the faceplate body 10 at functionally essential structural components 1. According to FIG. 10, the walling 43 of the second support element 40b has a length LR, which extends in the direction of the first support element 40a. Advantageously, the length LS of the protecting element 39 amounts to 30% LR≦LS≦200 LR. According to FIG. 6, the protecting element 30 has a width extension B, which is oriented vertically to the longitudinal extension L, wherein the width extension B amounts to 40% BS B 80, wherein BS is the longitudinal extension of the protecting side 52. Hereby, reliable variability can be achieved for the faceplate body 10 for accommodating different geometric dimensions of functionally essential structural components 1.

1. A faceplate body for a functionally essential structural component, with a faceplate having the appearance of at least one decorative element, and with a support element, which includes at least one attaching means for achieving an attachment to the functionally essential structural component, wherein the support element is made from plastic material.

2. The faceplate body according to claim 1,
wherein the attaching means with the support element forms a common, monolithic structural component and/or the attaching means is integrally interconnected to the support element.

3. The faceplate body according to claim 1,
wherein the attaching means includes a latching element and/or a clips element.

4. The faceplate body according to claim 1,
wherein the faceplate may be made from a material, which embodied in metal and/or glass and/or lumber and/or leather and/or plastic material.

5. The faceplate body according to claim 1,
wherein the faceplate includes a flat plate element, which has a front side and a back side, wherein the back side is facing and attached to the support element.

6. The faceplate body according to claim 1,
wherein the support element is configured with a cavity configured to accommodate at least partially the functionally essential structural component, wherein the cavity is delimited by a walling, and by a bottom of the support element.

7. The faceplate body according to claim 1,
wherein the support element is disposed at the faceplate such that the support element is visible from the outside, and the faceplate is disposed at the support element such that the bottom is covered by the faceplate and/or the walling in the mounted condition at the functionally essential structural component is at least partially visible from outside.

8. The faceplate body according to claim 1,
wherein the faceplate and the support element are embodied in that the faceplate body includes at least one rounded corner area and/or at least one angular corner area.

9. The faceplate body according to claim 1,
wherein the attaching means is configured in such a way at the support element that the attaching means is invisible from the outside such that the attaching means is located in the cavity.

10. The faceplate body according to claim 9,
wherein the walling includes the at least one attaching means.

11. The faceplate body according to claim 1,
wherein the support element includes several attaching means, wherein the attaching means are configured such that in the mounted condition at the functionally essential structural component, at least two attaching means differ in their holding force at the functionally essential structural component.

12. The faceplate body according to claim 1,
wherein the at least one attaching means protrudes into the cavity.

13. The faceplate body according to claim 1,
wherein the support element is configured frame-like.

14. The faceplate body according to claim 1,
wherein the course of the support element is adapted to the exterior contour of the faceplate, such that the faceplate has a geometric shape, which is rectangular or square or angular or L-shaped.

15. The faceplate body according to claim 1,
wherein the course of the support element is interrupted at least on one side.

16. The faceplate body according to claim 1,
wherein the walling includes at least four walling sides, wherein at least two opposite walling sides include the attaching means.

17. The faceplate body according to claim 1,
wherein the attaching means are disposed along the longitudinal extension of the faceplate body.

18. The faceplate body according to claim 1,
wherein an opening at the support element is associated to each attaching means.

19. The faceplate body according to claim 1,
wherein the faceplate is positively and/or non-positively and/or connected by substance to the support element, and at least one connecting element, which is invisible from the outside, ensures that a reliable attachment between the faceplate and the support element is provided.
